(19) United States
(12) Patent Application Publication
(10) Pub. No.: US 2015/0058058 A1
(43) Pub. Date: Feb. 26, 2015

(54) Automatic Detection of Network Conditions Prior to Engaging in Online Activities

(71) Applicant: Cisco Technology, Inc., San Jose, CA (US)

(72) Inventors: Qi Shi, Suzhou (CN); Huahua Yin, Suzhou (CN); Yi Lu, Suzhou (CN); Yunwei Luo, Suzhou (CN); Hua Ouyang, Suzhou (CN); Long'en Li, Suzhou (CN)

(73) Assignee: Cisco Technology, Inc., San Jose, CA (US)

(21) Appl. No.: 13/975,488

(22) Filed: Aug. 26, 2013

(51) Int. Cl. G06Q 10/10

(52) U.S. Cl. CPC G06Q 10/1095
USPC 705/7.19

(57) ABSTRACT

Techniques are described herein for establishing a network connection between a client device and a server over a network, and determining a network condition associated with engaging in an online activity by the client device over the network. In response to the network condition meeting an indicator criterion, a notification is provided to the client device prior to facilitating engagement of the client device in the online activity.

### TECHNICAL FIELD

The present disclosure relates to engaging in online activities, such as online meetings.

### BACKGROUND

Online meetings have become popular, due at least in part to the differences in locations between people as well as the use of mobile devices that facilitate engaging in such meetings while people are traveling and thus away from a main office.

When using an online meeting platform or service, at times certain meeting participants may join a meeting late due to a delay caused by slower network speeds (e.g., due to network bandwidth issues). For example, a meeting participant may be need to access an online meeting via a mobile device (e.g., laptop, note pad, smart phone, etc.) at a hotel or some public meeting place in which network conditions result in reduced network speeds. Conducting other online activities (e.g., accessing and/or downloading a software application online) can also be negatively affected by slower network speeds. In a scenario in which a meeting participant is important to an online meeting (e.g., the meeting participant may be the host or first presenter), other meeting participants will need to wait for the meeting participant to connect with the meeting, which can be considerably delayed when, shortly before the start time of the meeting, the meeting participant attempts to connect with a device to the network that supports the online meeting at a very slow network speed.

### BRIEF DESCRIPTION OF THE DRAWINGS

FIG. 1 is a schematic block diagram of an example system that facilitates online meetings between client devices that are hosted by one or more servers.

FIG. 2 is a schematic block diagram of an example client device that engages in an online meeting with other client devices via the system of FIG. 1, where the client device is configured with meeting application software that tracks a network speed associated with a network to which the client device is currently connected and provide information to the client device prior to engaging in an online activity.

FIG. 3 is a schematic block diagram of an example embodiment of a server that hosts online meetings for the system of FIG. 1, where the server also includes meeting application software that communicates with the client device of FIG. 2 to track network speed over the network to which the client device is currently connected.

FIG. 4 is a flow chart depicting an example process for automatic detection of network speed over a network to which a client device is connected using the system of FIG. 1 so as to alert a user of the client device prior to engaging in an online activity.

FIG. 5 depicts an example embodiment schematically depicting an example process for tracking network speed based upon communications between a client device and a host server for the system of FIG. 1.

FIG. 6 depicts an example embodiment of an indicator display for a user interface associated with a client device for the system of FIG. 1, where the indicator display provides an indication of network speed at a selected time prior to the client device engaging in an online activity.

### DESCRIPTION OF EXAMPLE EMBODIMENTS

### Overview

Techniques are presented herein for establishing a network connection between a client device and a server over a network, and determining a network condition associated with engaging in an online activity by the client device over the network. In response to the network condition meeting an indicator criterion, a notification is provided to the client device prior to facilitating engagement of the client device in the online activity.

### Example Embodiments

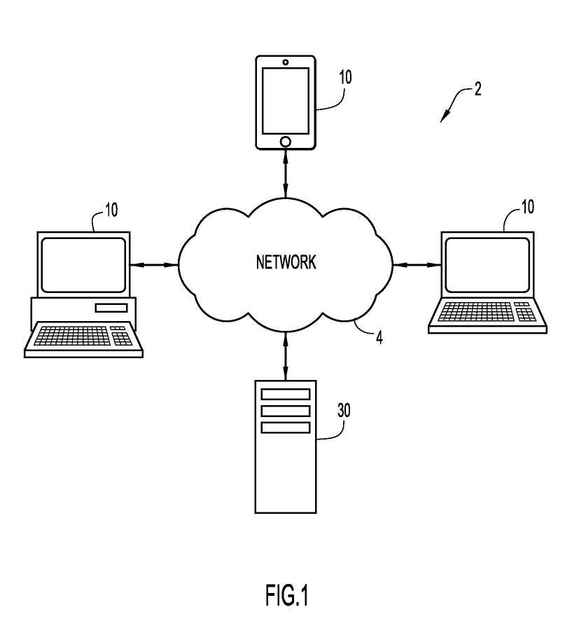

An example embodiment of a system that supports online meetings and other types of communications and sharing or exchange of content between client devices, including PC client devices and mobile client devices, is depicted in the schematic diagram of FIG. 1. The system of FIG. 1 also supports one or more client devices engaging in any other types of online activities (e.g., downloading of software applications or other content). As used herein, the term “online meeting” or “online meeting session” refers to a communication between at least two client devices that can include audio and/or video content (e.g., a video meeting, where images of users at different client devices are captured and provided to other client devices as part of the communication) as well as the sharing of content (e.g., sharing of files or documents, such as word processing documents, spreadsheet documents, slide presentations, etc., sharing of images and the sharing of any other types of content), where the online meeting session is hosted by one or more servers and occurs over one or more suitable networks to which the client devices and host server(s) are connected.

Referring to FIG. 1, a system 2 comprises a network 4 that facilitates exchange of communications and content (e.g., sharing of documents or files, images, video, etc.) between client devices 10 via one or more host server devices 30. While three client devices 10 and one server device 30 are shown, this is for example purposes only, and it is noted that the network 4 can support communications and exchange of content between any suitable number of client devices and host server devices. Examples of types of networks that can be utilized within system 2 include, without limitation, any one or more of local or wide area networks, Internet Protocol (IP) networks such as intranet or internet networks, telephone networks (e.g., public switched telephone networks), wireless or mobile phone or cellular networks, and any suitable combinations thereof.

As shown in the example embodiment of FIG. 1, different client devices 10 may be engaged in an online meeting session at any given time. For example, client devices can include any suitable types of computing devices including, without limitation, personal computer (PC) devices, such as stationary (e.g., desktop) computers, or any other type of mobile computing device such as note pads, tablets, personal data assistant (PDA) devices, and other portable media player devices, and cell phones (e.g., smartphones). Each of the client devices 10 includes suitable processors, input and output (I/O) devices, memory and software as described herein to facilitate communications with other client devices over the network 4 and via host server(s) 30, including engaging in online meetings (e.g., video meetings) with sharing of content during such meetings. Each client device 10 further includes suitable software to facilitate engaging in any other suitable online activities (e.g., downloading of one or more software applications, such as a meeting client application in preparation for an online meeting) over the network 4 as described herein.

Suitable server devices 30 can be any suitable types of stationary or other types of computing devices capable of hosting and managing online meetings and also, optionally, other types of communication sessions between client devices 10 (e.g., email, instant messaging or SMS communications, posting of content in blogs or other virtual environments, support of chat rooms, communities or other forms of social networking platforms) or any other types of online activities for one or more client devices 10.

The client devices and servers can utilize any suitable operating systems (e.g., Android, Windows, Mac OS, Symbian OS, RIM Blackberry OS, Linux, etc.) to facilitate interaction, communications, sharing of content between client devices 10 as well as engaging in any other types of online activities by client devices 10 over the network 4. In addition, the techniques described herein for enhancing the experience particularly for users of mobile devices during sharing of content in an online meeting can be implemented utilizing any suitable types of commercial software products and associated services that support such communications and sharing of content between client devices. Some examples of software products and associated services with which the techniques described herein can be integrated include, without limitation, WebEx (Cisco Systems, Inc.) and LotusLive (IBM Corporation).

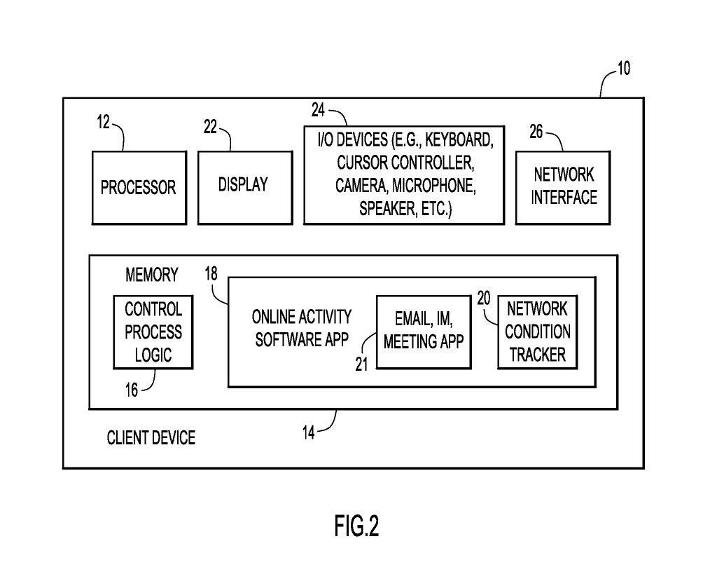

An example embodiment of a client device 10 is depicted in the block diagram of FIG. 2. In particular, the client device 10 includes a processor 12, a memory 14, a network interface 26, and a display 22 (e.g., LCD or any other suitable type of display screen). The client device also includes one or more suitable input and/or output (I/O) devices (depicted generally as box 24) including, without limitation, a keyboard, a cursor controller (e.g., mouse pad, touch pad or touch screen), a camera, a microphone, speaker(s), etc.

The network interface 26 of the client device 10 can be, for example, one or more of an Ethernet interface card or switch, a modem, a router or any other suitable hardware device that facilitates a wireless and/or hardwire connection over the network 4 with one or more server devices 30 and other client devices 10, where the network interface unit can be integrated within the device or a peripheral that connects with the device. As described herein, the network interface 26 can be configured with one or more suitable components to facilitate switching of the device 10 from one network (e.g., a wireless Ethernet connection via a connection site, such as a hotel, a meeting room, an office, etc.) to another (e.g., a broadband mobile network, such as a 3G or 4G broadband network).

The memory 14 of the client device 10 may comprise read only memory (ROM), random access memory (RAM), magnetic disk storage media devices, optical storage media devices, flash memory devices, electrical, optical, or other physical/tangible memory storage devices, and any combinations thereof. The processor 12 can comprise at least one microprocessor that executes control process logic instructions 16 stored within memory 14 including operational instructions and software applications stored within such memory (e.g., operation of an online activity software application module 18 as described herein). Thus, in general, the memory 10 may comprise one or more tangible (non-transitory) computer readable storage media (e.g., a memory device) encoded with software comprising computer executable instructions and when the software is executed (by the processor 12) it is operable to perform the operations described herein for automatic detection and tracking or monitoring of network conditions for a client device prior to engaging in an online activity such as an online meeting.

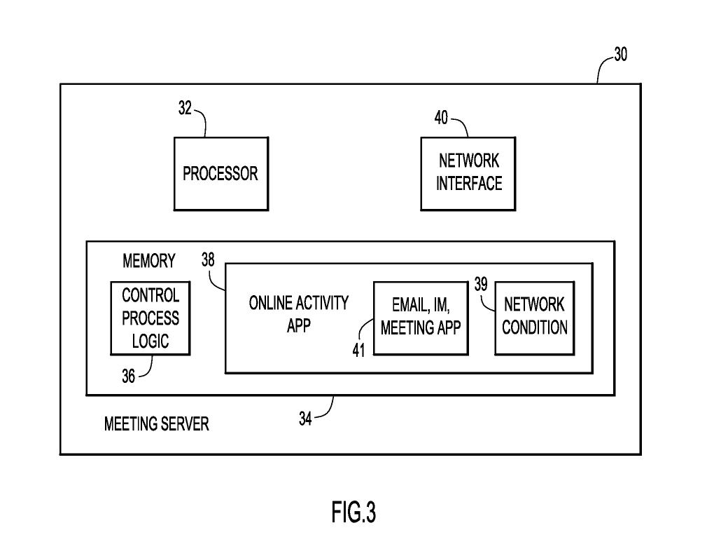

An example embodiment of a meeting server 30 that can be used in the system 2 of FIG. 1 is depicted in the block diagram of FIG. 3. Server 30 includes a processor 32, a memory 34, and a network interface 40. The memory 34 includes control process logic 36, a meeting application module 38 and/or other suitable software for performing operations in relation to the techniques described herein. The processor 32, network interface 40 and memory 34 for the meeting server 30 can be of the same or similar types and have the same or similar functionalities as previously described herein in relation to the client device 10.

The memory 14 of each client device 10 includes an online activity software application module 18 that comprises one or more software applications that facilitate online activities over the network, including downloading of online content, engaging in online activities (e.g., gaming or other activities) with one or more servers (e.g., servers 30) over the network, and engaging in online meetings and/or other types of communications with other client devices 10 over the network (where the online meetings are hosted by one or more host meeting servers 30). The term “online activity” as used herein refers to any activity that a client device 10 engages in over the network that includes exchange of content or information with one or more other computing devices in any context (e.g., engaging with other client devices and/or server devices within an online meeting, engaging with any other server device or other computing device in any other manner over the network, e.g., the Internet).

Each meeting server 20 also includes an online activity application software module 38 comprising one or more software applications that facilitate hosting by the server 30 of various online activities, including hosting of online meetings and related activities associated with such online meetings (e.g., sharing of content between client devices 10, as well as other types of communications) over a suitable software platform (e.g., via a Cisco WebEx software platform, a LotusLive software platform or any other suitable software platform).

The online activity software application modules 18, 38 stored in the memories 14, 34 of each client device 10 and each server 30 include a software module that facilitates detection and tracking or monitoring of network conditions for the client devices 10 in order to provide an indication to the client devices 10 in relation to upcoming or anticipated online activities (e.g., an anticipated online meeting) in accordance with techniques described herein. In particular, a client device 10 includes a network condition tracker module 20, while a server 30 includes a network condition module 39, where these modules 20, 39 facilitate detection and tracking of a current network condition associated with the client device 10 based upon communications between the client device 10 and the server 30 as described herein, and the detection and tracking/monitoring of the current network condition can be used to provide information to a user of the client device 10 prior to engaging in an online activity. The online activity software application module 18 of the client device 10 further includes any suitable software applications that facilitate various types of online communications and other activities between the client device 10 and other client devices over a network including, without limitation, emailing (e.g., utilizing email software that includes calendar functions), instant messaging, engaging in online social networking platforms that support a wide range of online activities (e.g., chat rooms, social groups or communities, social tagging of content, blogging, etc., generally depicted in FIG. 2 as application software module 21). The online activity software application module 38 of the server 30 also includes software applications that facilitate hosting of such online communications and other activities between client devices over one or more networks (generally depicted in FIG. 3 as application software module 41).

As previously noted herein, as computing devices become smaller and portable while providing the same or substantially similar capabilities as stationary computing devices, users of such computing devices can engage in many online activities, including the downloading of software content (e.g., plug-in or other software apps) and engaging in online activities hosted by one or more servers (e.g., online meetings, online gaming, etc.). However, the network at which a computing device must connect may not always be as reliable or as fast at some locations compared to others (e.g., depending upon the number of users connected with a particular network, as well as a number of other factors). For example, a user of a client device that wishes to engage in an online activity (e.g., an online meeting) utilizing an online network provided at a hotel or at some public location (e.g., a library, an airport, etc.) may not have network conditions that are as desirable in comparison to the network conditions associated with a network at the user's home or office. A slower network speed would slow down operation of the online activity for the user, thus impacting the user experience. This can further frustrate the online activity if, e.g., the user is engaging in an online meeting or other online activity with other participants and the user is an integral part of the activity (e.g., the user is a presenter or a required participant of an online meeting, and the meeting cannot progress until the user is sufficiently engaged in the online meeting).

The techniques described herein facilitate a detection and tracking/monitoring of a current network condition associated with a client device so as to provide an indication to the client device prior to engaging in an online activity, thus allowing the client device to take appropriate action (if desired) to mitigate any potential delays in relation to the online activity due to the current network condition. The example embodiments described herein are in relation to a client device engaging in an online meeting with other client devices over a network and that is hosted by one or more meeting servers. However, it is noted that the techniques and associated devices/products described herein are not limited to online meetings but instead can be implemented with any other types of online activities including, without limitation, uploading and/or downloading of online applications or other online content (e.g., audio content, video content, documents and/or any other types of content) or engaging in any other types of online services (e.g., online gaming services, social networking services, etc.).

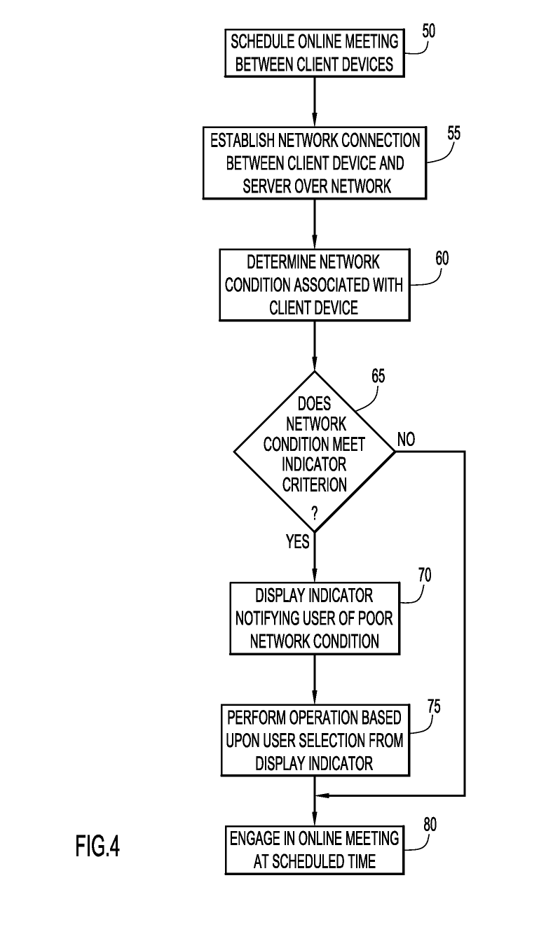

An example embodiment is now described with reference to the figures, in particular the flow chart of FIG. 4. At 50, an online meeting is scheduled between client devices 10. The scheduling of an online meeting can occur utilizing any suitable online meeting software platform (e.g., any online meetings facilitated using a WebEx platform, provided by Cisco Systems, Inc.), and further utilizing emailing software applications with calendaring functions (e.g., provided by the online activity software application module 18). An example embodiment of scheduling an online meeting comprises a participant sending an invitation communication (e.g., by email) via client device 10 to other client devices 10. The invitation communication can include information relating to the meeting including, e.g., an HTML link or other suitable information that provides access to the meeting (e.g., by allowing a client device to connect with a meeting server so as to engage in the online meeting). An acceptance to attend the online meeting by a client device can further generate a future calendar event associated with the meeting that provides a notification for the client device as the meeting time approaches (e.g., within any selected time period prior to the meeting time).

At 55, the client device 10 establishes a network connection (utilizing network interface 26) with a meeting server 30 over the network 4. It is noted that step 55 includes establishing a network connection at any point in time in relation to the online meeting invitation being processed. For example, a network connection may be established at the client device 10, where the online meeting invitation is processed (e.g., receipt of a meeting invitation by email at the client device, acceptance of the meeting invitation and a calendaring event that schedules the meeting in a calendar associated with the client device), and the same network connection exists up to a point in time at which a notification is provided that the meeting will soon commence (e.g., the meeting invite and scheduled meeting occur on the same day or even within hours or minutes of each other). In another example, a network connection may be established at the client device 10 after the processing of the online meeting invitation (e.g., meeting invite and meeting time are separated by one or more days, the online meeting invitation and online meeting occur using different client devices associated with the same user and/or the client device connects with separate networks when processing the online meeting invitation and engaging in the online meeting).

At 60, a network condition associated with the client device 10 is detected and tracked or monitored at some point in time prior to the scheduled online meeting. The network condition tracker module 20 and/or network condition module 39 can monitor the email calendar account associated with the user of the client device 10 to determine when a scheduled online meeting is approaching (e.g., in a manner similar to monitoring of other calendar events for providing reminder notifications to a client device), and the network condition can be detected and monitored or tracked at a selected or predetermined point in time prior to initiation or occurrence of the meeting event (e.g., within an hour or hours of the meeting event, within minutes of the meeting event, etc.).

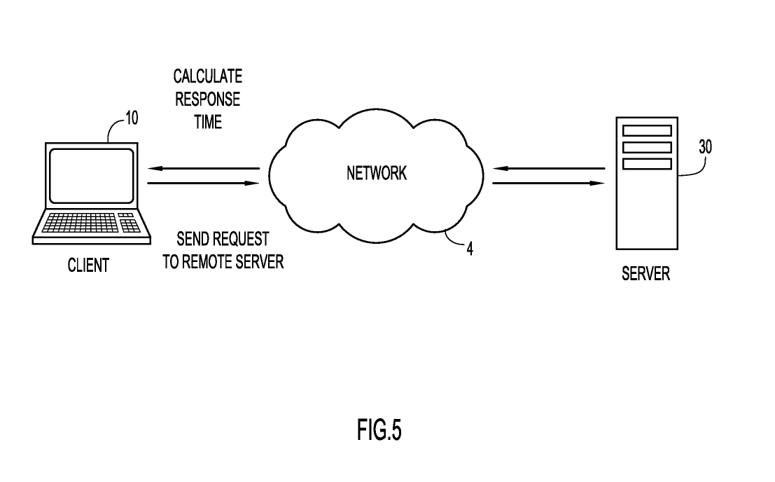

An example embodiment is depicted in FIG. 5 showing how a network condition can be detected and monitored utilizing modules 20 and 39 and in accordance with techniques described herein. The client device 10 communicates with a host server 30 to determine a response time associated with a communication between these computing devices, where the response time is used to determine a network condition (e.g., network speed) associated with the client device 10. Any suitable number of different types of techniques can be implemented to determine the network condition. For example, when utilizing a WebEx meeting platform (Cisco Systems, Inc.), there are a number of types of plug-in software application tools or other suitable software applications that can be integrated with email and/or other communication applications associated with the client device 10 that facilitate determining and monitoring a network condition based upon response time for a communication between the client device 10 and the server 30. In addition, any one or more types of network conditions can be detected and monitored to provide an indication of the current performance of a network to which the client device is connected. Examples of types of network conditions include, without limitation, network speed (e.g., a time at which it takes for a message and/or downloaded/uploaded content to be communicated between at least two computing devices over the network) or bandwidth (e.g., amount of data transferred per time period, such as a bit rate of kilobits per second or megabits per second), network latency, quality of communications over the network (e.g., measured by drops in data packets communicated between computing devices), etc. While the examples described herein determine a network condition based upon network speed, it is noted that any other suitable type of network condition can also be detected and monitored to provide an indication of the performance of the network prior to engaging in an online activity.

In one example embodiment, a plug-in software tool can be implemented for an email software application such as Outlook email (Microsoft Corporation), which allows a user to schedule an online meeting as well as implement a number of other functions associated with an online meeting (e.g., join the meeting) for a meeting software platform (e.g., a WebEx meeting platform) within the email software application. The plug-in software tool includes a software application that continues to run on the client device 10 and is thus operational even when the email software application is not open or running.

Other example embodiments of software applications that can be implemented with modules 20 and 39 include unified communications applications that are used for determining presence, instant communication services and other services within a social networking/collaboration platform. Some non-limiting examples of unified communications applications that can be utilized to determine and monitor a network condition associated with a client device include Cisco Jabber unified communications applications, Cisco Connect applications and WebEx Social applications (Cisco Systems, Inc.).

A network condition, such as network speed, can be determined using modules 20 and 39 based upon communications between the client device 10 and server 30 and any suitable technique that is capable of measuring the network condition based upon such communications. In an example embodiment, the client device 10 communicates with the server 30 to request a download of content (e.g., an image file). The time it takes to download the content at the client device 10 is determined (e.g., from start or initiation time of the download request to completion time at which the content is downloaded to the client device), and this is used to determine a network speed associated with the client device 10. In another example embodiment, utilizing a plug-in and/or other type of application of the module 20 at the client device 10, a detect network speed function can be implemented in which the module 20 detects the network speed based upon one or more communications with server 30 (e.g., pinging a server to obtain a communication response time, such as a time at which a communication originating at the client device 10 is routed from the server 30 back to the client device 10). The module 20, utilizing one or more applications, can also utilize a suitable API that is known for an operating system (e.g., a Windows OS provided by Microsoft Corporation or a Mac OS provided by Apple, Inc.) for obtaining network status information including network operating speed.

The module 20 of the client device 10 determines a suitable time prior to the scheduled online meeting time (or other online activity) at which to determine the network condition associated with the client device. For example, detecting and monitoring of the network condition (e.g., network speed) can be implemented within 30 minutes of the scheduled online meeting time, within 1 hour or longer of the scheduled online meeting time, or at any other suitable time interval. The network condition can further be monitored at regular intervals (e.g., intervals over a period of seconds or minutes) to determine whether there is any significant change in the network condition over time.

At 65, a determination is made regarding whether the determined network condition meets at least one indicator criterion. In an example embodiment in which the determined network condition comprises the network speed, the network speed can be compared with one or more criteria that designate whether the network speed is acceptable (e.g., fast enough to be suitable for operation of the client device during the online meeting) or unacceptable (e.g., too slow to be suitable for operation of the client device during the online meeting).

In an example embodiment as previously described in which the network speed is based upon a connection time (e.g., time required from initiation of a communication message from the client device to the server to the time in which a response communication message is received at the client device from the server), a network speed can be determined as follows:

| Connection Time | Network Speed |
|---|---|
| Less than 1 second | Fast |
| Between 1 and 3 seconds | Medium |
| Greater than 3 seconds | Slow |

In this example, the indicator criterion would be satisfied if the network speed was detected as being slow.

Any other suitable mechanism for establishing a network speed and an indicator criterion for the network speed can also be utilized. For example, the network speed can be based upon a download and/or upload rate at which content is communicated between the client device 10 and server 30 (e.g., based upon a data transfer rate in kilobits/sec, megabits/sec, etc.), where the download and/or upload rate is compared with a threshold rate value that provides an indication as to whether the rate is acceptable (thus outside of the threshold criterion) or unacceptable (thus meeting the indicator criterion).

In response to a determination that the network condition meets the indicator criterion, at 70 an indicator is displayed by the client device 10 (via one or more applications of the module 20). The indicator display provides an indication to the user of the client device 10 that the network condition is poor and may be unacceptable for engaging in the online meeting that is scheduled in the near future. The indicator display may further provide one or more interactive control buttons or icons that provide input control for selection by the user (e.g., via a pointer or other icon that is user controlled with a mouse, input touch pad or touch screen, etc.) to control further operations of the client device 10 in relation to engaging in the scheduled online meeting.

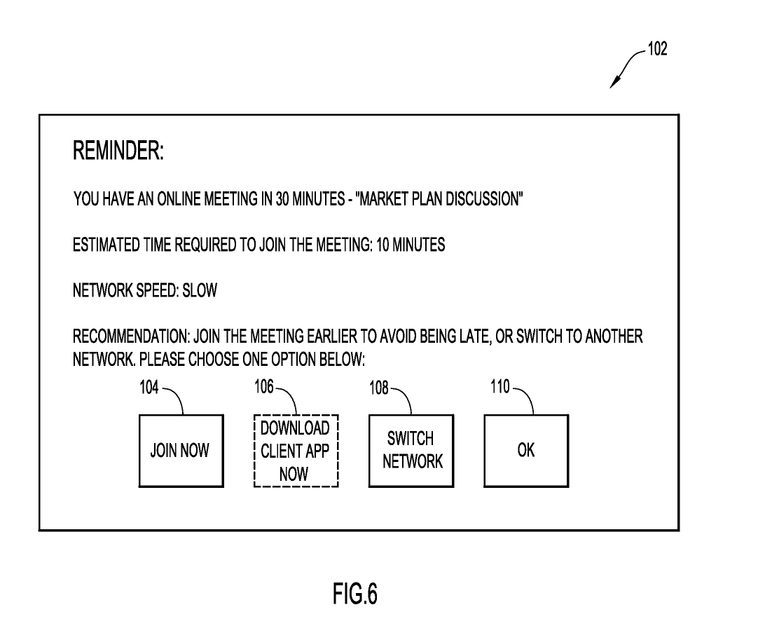

An example embodiment of an indicator display is depicted in FIG. 6. The indicator display 102 can be implemented as a pop-up window or similar type of message that automatically appears (e.g., within a user interface of an email application or other type of communication application or, alternatively, at the desktop screen) in the display 22 of the client device 10 at a selected or predetermined time that is prior to the scheduled online meeting time (e.g., at about 30 minutes from the scheduled meeting time as shown in the embodiment of FIG. 6). The display 102 provides an indication to the user of the client device 10 that the current network condition is poor (e.g., network speed is slow), as well as a recommendation that the user take some action to avoid being late or missing a portion of the meeting. The display 102 further includes interactive control buttons or icons 104-110 which, at 75, allow the user of the client device 100 to select an operation to be implemented by the client device 100 for a particular scenario.

For example, the user may select control icon 104 to join the online meeting immediately (i.e., in response to viewing the indicator display 102) in order to provide sufficient time to connect to the meeting due to the poor network condition.

Another control icon 106 is optionally provided (where icon 106 is provided in dashed lines to show it as optional) that allows a user to begin downloading a client application needed for the online meeting. For example, for certain client devices (depending upon what software applications may or may not already be loaded in the module 20 of a client device 10), a plug-in tool or other software application may be required to be downloaded from a remote location (e.g., from the meeting server) in order to enable the client device 10 to connect to the online meeting. In a scenario in which a participant may be using a client device 10 at some remote location (e.g., a participant may be joining an online meeting using a laptop device in a hotel room) and the participant has not yet downloaded the necessary software required for the client device 10 to connect to the online meeting, it may take some time for the client device 10 to join the meeting, particularly when the network connection meets the indicator criterion (e.g., network speed for the network at the hotel is very slow). The control icon 106 provides the user with the option of downloading the necessary software for the client device at a time period well before the start of the scheduled online meeting, where selecting icon 106 results in the client device immediately downloading such software.

A further control icon 108 provides the user with the option of switching the client device 10 to another network (assuming this is an option). For example, in a scenario in which a user is in a hotel room and has a client device 10 such as a laptop or note pad that is currently connected with the network for the hotel that has been detected as having a slow network speed, the client device 10 may also have the capability of connecting, via the network interface 26, to another network (e.g., over a broadband mobile network, such as a 3G or 4G broadband network). The user may be provided with the option of switching networks to ensure that the client device 10 can connect with the online meeting in a timely manner and be provided with sufficient functional operational features during the online meeting.

Another icon 110 allows the user to proceed without any further operation (e.g., by selecting the OK icon 110, the indicator display 102 is simply closed). Any other suitable interactive control icons can also be provided that allow the user to select any one or more other operations to be performed by the client device 10 in response to being notified that a network condition is poor and may impact performance of the online meeting that is scheduled to begin in the near future.

At 80, the online meeting commences at its scheduled time, and the client device joins the meeting. Based upon the poor network condition that was previously detected at 60 and 65 and the optional implementation of a previous operation by the client device at 75 (e.g., starting the online meeting earlier, pre-loading necessary software for the online meeting, switching networks, etc.), delayed access to the online meeting as well as potentially missing portions of the meeting can be minimized or avoided.

Thus, the techniques described herein facilitate early detection of poor network conditions associated with a client device prior to engaging in an online activity by a user so as to minimize the impact associated with such poor network conditions. In scenarios in which the online activity is a scheduled online meeting, a notice or indicator display provided to a user of the client device allows the user to mitigate the impact on the scheduled online meeting due to a poor network condition by either implementing operational steps associated with the online meeting at an earlier time period, switching to another network for connecting with the online meeting, etc. The techniques are also useful for implementing prior to any other online activity, such as downloading and/or uploading of content from the client device to a server or other computing device.

The above description is intended by way of example only.

What is claimed is:

1. A method comprising:
establishing a network connection between a client device and a server over a network;
determining a network condition associated with engaging in an online activity by the client device over the network; and
in response to the network condition meeting an indicator criterion, providing a notification to the client device prior to facilitating engagement of the client device in the online activity.

2. The method of claim 1, wherein the determining a network condition comprises determining a network speed based upon a communication provided between the client device and the server over the network.

3. The method of claim 2, wherein the communication comprises at least one of downloading and uploading content between the client device and the server over the network.

4. The method of claim 1, wherein the online activity comprises an online meeting between the client device and other client devices.

5. The method of claim 4, wherein the notification comprises an indicator display providing an indication of the network condition and a scheduled future time of the online meeting.

6. The method of claim 5, wherein the notification further comprises at least one interactive control icon that facilitates input of a control operation at the client device prior to engaging in the online meeting, and the method further comprises:
in response to selection of the at least one interactive control icon, automatically performing an operation by the client device associated with the online meeting.

7. The method of claim 6, wherein the at least one interactive control icon facilitates control of at least one of automatically joining the online meeting, downloading an application associated with the online meeting, and switching from the network to another network.

8. An apparatus comprising:
a communication interface device configured to enable communications over one or more networks; and
a processor coupled to the communication interface, and configured to:
establish a network connection between the apparatus and a server over a network;
determine a network condition associated with engaging in an online activity by the apparatus over the network; and
in response to the network condition meeting an indicator criterion, provide a notification to the apparatus prior to facilitating engagement of the apparatus in the online activity.

9. The apparatus of claim 8, wherein the processor is configured to determine a network condition by determining a network speed based upon a communication provided between the apparatus and the server over the network.

10. The apparatus of claim 9, wherein the processor is configured to facilitate the communication by at least one of downloading and uploading content between the apparatus and the server over the network.

11. The apparatus of claim 8, wherein the online activity comprises an online meeting between the apparatus and at least one client device.

12. The apparatus of claim 11, further comprising a display device, and the processor is configured to provide the notification by providing an indicator display via the display device that provides an indication of the network condition and a scheduled future time of the online meeting.

13. The apparatus of claim 12, wherein the notification further comprises at least one interactive control icon that facilitates input of a control operation at the apparatus prior to engaging in the online meeting, and the processor is further configured to:
in response to selection of the at least one interactive control icon, automatically perform an operation associated with the online meeting.

14. The apparatus of claim 13, wherein the processor is further configured to facilitate control of the apparatus, via the at least one interactive control icon, of at least one of automatically joining the online meeting, downloading an application associated with the online meeting, and switching from the network to another network.

15. One or more computer readable storage media encoded with software comprising computer executable instructions and when the software is executed operable to:
establish a network connection between a client device and a server over a network;
determine a network condition associated with engaging in an online activity by the client device over the network; and
in response to the network condition meeting an indicator criterion, provide a notification to the client device prior to facilitating engagement of the client device in the online activity.

16. The computer readable storage media of claim 15, wherein the instructions are further operable to determine a network condition by:
determining a network speed based upon a communication provided between the client device and the server over the network.

17. The computer readable storage media of claim 16, wherein the communication comprises at least one of downloading and uploading content between the client device and the server over the network.

18. The computer readable storage media of claim 15, wherein the online activity comprises an online meeting between the client device and other client devices.

19. The computer readable storage media of claim 18, wherein the instructions are further operable to provide the notification as an indicator display providing an indication of the network condition and a scheduled future time of the online meeting.

20. The computer readable storage media of claim 19, wherein the instructions are further operable to provide the notification as at least one interactive control icon that facilitates input of a control operation at the client device prior to engaging in the online meeting, and the instructions are further operable to:
in response to selection of the at least one interactive control icon, automatically perform an operation by the client device associated with the online meeting.

21. The computer readable storage media of claim 20, wherein the instructions are further operable to facilitate control, via the at least one interactive control icon, of at least one of automatically joining the online meeting, downloading an application associated with the online meeting, and switching from the network to another network.
